(19) United States
(12) Patent Application Publication
(10) Pub. No.: US 2015/0072736 A1
(43) Pub. Date: Mar. 12, 2015

(54) APPARATUS AND METHODS FOR NEGOTIATING PROACTIVE POLLING INTERVAL

(71) Applicant: QUALCOMM Incorporated, San Diego, CA (US)

(72) Inventors: Michele Berionne, San Diego, CA (US); Jose Alfredo Ruvalcaba, Winchester, CA (US); Xiaomin Zhu, San Diego, CA (US)

(73) Assignee: QUALCOMM Incorporated, San Diego, CA (US)

(21) Appl. No.: 14/276,680

(22) Filed: May 13, 2014

Related U.S. Application Data
(60) Provisional application No. 61/876,863, filed on Sep. 12, 2013.

(51) Int. Cl. H04B 1/38

(52) U.S. Cl. CPC H04B 1/3816
USPC 455/558

(57) ABSTRACT

Aspects of the present disclosure are directed to a polling interval negotiation scheme between a universal integrated circuit card (UICC) and a wireless terminal. A wireless terminal and a UICC are communicating at a first polling interval. The wireless terminal may send a proposed polling interval to the UICC. The wireless terminal determines a response of the UICC to the proposed polling interval, and communicates with the UICC at a second polling interval based on the response of the UICC.

### CROSS-REFERENCE TO RELATED APPLICATION

This application claims priority to and the benefit of provisional patent application No. 61/876,863 filed in the United States Patent and Trademark Office on 12 Sep., 2013, the entire content of which is incorporated herein by reference.

### TECHNICAL FIELD

Aspects of the present disclosure relate generally to wireless communications, and more particularly, proactive polling interval negotiation between a universal integrated circuit card and a wireless terminal

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). UMTS also supports enhanced 3G data communications protocols, such as High Speed Packet Access (HSPA), which provides higher data transfer speeds and capacity to associated UMTS networks.

A wireless terminal may include a smart card such as a universal integrated circuit card (UICC) or integrated circuit card (ICC) (also commonly referred to as SIM card). For example, in a GSM network, the UICC contains a SIM application, and in a UMTS network, it contains a USIM application. In an IS-95/CDMA2000 network, the UICC contains a CSIM application. A UICC may contain several applications (e.g., SIM, USIM, and/or CSIM), making it possible for the same smart card to have access to multiple networks such as GSM, UMTS, and IS-95/CDMA2000 networks. Hereafter, the SIM, USIM, or CSIM application may be generally referred to as the SIM application for ease of description. A UICC including one or more SIM applications may be referred to as a SIM card or SIM in this specification.

The UICC has a card application toolkit (CAT) that provides a set of applications and related procedures that may be used during a card session with the UICC. One example of CAT is described in the ETSI (European Telecommunications Standards Institute) Technical Specification 102 223, incorporated herein by reference. The CAT provides mechanisms that allow applications (e.g., SIM, USIM, or CSIM), existing in the UICC, to interact and operate with any terminal or user equipment, which supports the specific mechanism(s) used by the application. Among the mechanisms, proactive UICC (proactive command) provides a mechanism whereby the UICC can initiate actions to be taken by the terminal. On the other hand, the terminal can send different envelope commands to the UICC to initiate communication or response to proactive commands.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Aspects of the present disclosure are directed to a proactive polling interval negotiation scheme between a universal integrated circuit card (UICC) and a wireless terminal including the same. In various aspects of the disclosure, the UICC allows the wireless terminal to propose a proactive polling interval that better suits the requirements and capabilities of the wireless terminal, and the UICC may accept, modify, or reject the proposed polling interval.

In one aspect, the disclosure provides a method of operating a wireless terminal capable of performing proactive polling interval negotiation. The wireless terminal communicates with a UICC at a first polling interval. The wireless terminal sends a command to the UICC, wherein the command includes a proposed polling interval. Then, the wireless terminal determines a response of the UICC to the proposed polling interval, and communicates with the UICC at a second polling interval based on the response of the UICC.

In another aspect of the disclosure, a universal integrated circuit card (UICC) communicates with a wireless terminal at a first polling interval and indicates support of polling interval negotiation. The UICC receives a command from the wireless terminal, wherein the command includes a proposed polling interval. Then, the UICC determines a response to the proposed polling interval and communicates with the wireless terminal at a second polling interval based on the response.

In another aspect of the disclosure, a wireless terminal includes means for communicating with a universal integrated circuit card (UICC) at a first polling interval; and means for sending a command to the UICC, wherein the command includes a proposed polling interval. The wireless terminal further includes means for determining a response of the UICC to the proposed polling interval and means for communicating with the UICC at a second polling interval based on the response from the UICC.

In another aspect of the disclosure, a universal integrated circuit card (UICC), includes means for communicating with a wireless terminal at a first polling interval and indicating support of polling interval negotiation; and means for receiving a command from the wireless terminal, wherein the command includes a proposed polling interval. The UICC further includes means for determining a response to the proposed polling interval; and means for communicating with the wireless terminal at a second polling interval based on the response.

In another aspect of the disclosure, a wireless terminal includes at least one processor, a communication interface coupled to the at least one processor, and a memory coupled to the at least one processor. The at least one processor includes a first component configured to communicate with a universal integrated circuit card (UICC) at a first polling interval; and a second component configured to send a command to the UICC, wherein the command includes a proposed polling interval. The at least one processor further includes a third component configured to determine a response to the proposed polling interval, and a fourth component configured to communicate with the UICC at a second polling interval based on the response of the UICC.

In another aspect of the disclosure, a universal integrated circuit card (UICC) includes at least one processor, a communication interface coupled to the at least one processor, and a memory coupled to the at least one processor. The at least one processor includes: a first component configured to communicate with a wireless terminal at a first polling interval and indicate support of polling interval negotiation; and a second component configured to receive a command from the wireless terminal, wherein the command includes a proposed polling interval. The UICC further includes a third component configured to determine a response to the proposed polling interval, and a fourth component configured to communicate with the wireless terminal at a second polling interval based on the response.

In another aspect of the disclosure, a wireless terminal includes a communication component configured to communicate with a universal integrated circuit card (UICC) at a polling interval negotiated between the wireless terminal and the UICC, and a polling interval negotiation component configured to negotiate the polling interval with the UICC by sending at least one proposed polling interval to the UICC. The communication component is configured to change the polling interval from a first polling interval to a second polling interval based on a response of the UICC to the proposed polling interval.

In another aspect of the disclosure, a universal integrated circuit card (UICC) includes a communication component configured to communicate with a wireless terminal at a polling interval negotiated between the UICC and the wireless terminal, and a polling interval negotiation component configured to negotiate the polling interval with the wireless terminal by receiving at least one proposed polling interval from the wireless terminal. The communication component is configured to change the polling interval from a first polling interval to a second polling interval based on a response of the UICC to the proposed polling interval.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a block diagram conceptually illustrating an example of a telecommunications system.

FIG. 2 is a block diagram illustrating an example of a hardware implementation for an apparatus employing a processing system.

FIG. 3 is a block diagram conceptually illustrating a universal integrated circuit card (UICC) in accordance with an aspect of the disclosure.

FIG. 4 is a block diagram conceptually illustrating a wireless terminal and a UICC configured to perform proactive polling interval negotiation in accordance with various aspects of the disclosure.

FIG. 5 is a communication flow diagram illustrating proactive polling interval negotiation between a wireless terminal and UICC in accordance with an aspect of the present disclosure.

FIG. 6 is a communication flow diagram illustrating proactive polling interval negotiation between a wireless terminal and UICC in accordance with an aspect of the disclosure.

FIG. 7 is a flow chart illustrating an example of proactive polling interval negotiation process between a wireless terminal and UICC in accordance with an aspect of the present disclosure.

FIG. 8 is a flow chart illustrating a method of proactive polling interval negotiation operable at a wireless terminal in accordance with an aspect of the disclosure.

FIG. 9 is a flow chart illustrating a method of proactive polling interval negotiation operable at a UICC in accordance with an aspect of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Aspects of the present disclosure are directed to a proactive polling interval negotiation scheme between a universal integrated circuit card (UICC) and a wireless terminal operatively coupled with the UICC. The disclosed polling interval negotiation scheme provides the wireless terminal the ability to negotiate a more desirable polling interval with the UICC. In general, a wireless terminal may perform proactive polling to retrieve a proactive command from a UICC. This is typically performed every thirty seconds (polling interval), but the UICC can change the polling interval. For example, the UICC may use a POLL INTERVAL command, which is described in the European Telecommunication Standards Institute (ETSI) Technical Specification (TS) 102 223, to change the polling interval. In addition, the UICC may completely stop polling by sending a POLLING OFF command, which is also described in ETSI TS 102 223.

In some cases, such as machine-to-machine devices, it is desirable for the wireless terminal to be able to propose and negotiate a proactive polling interval, for example, in order to reduce battery power consumption. While the wireless terminal is aware of its specific battery and usage requirements, this information is not readily available to the UICC. Therefore, it is the wireless terminal that can determine the most appropriate polling interval. In accordance with aspects of the disclosure, the wireless terminal can propose and negotiate with the UICC to arrive at a proactive polling interval that matches the power and usage pattern of the wireless terminal. In addition, the UICC can accept, modify, or reject the proposed proactive polling interval. In some aspects of the disclosure, new proactive and envelope commands are introduced to facilitate a proactive polling interval negotiation scheme between the UICC and wireless terminal.

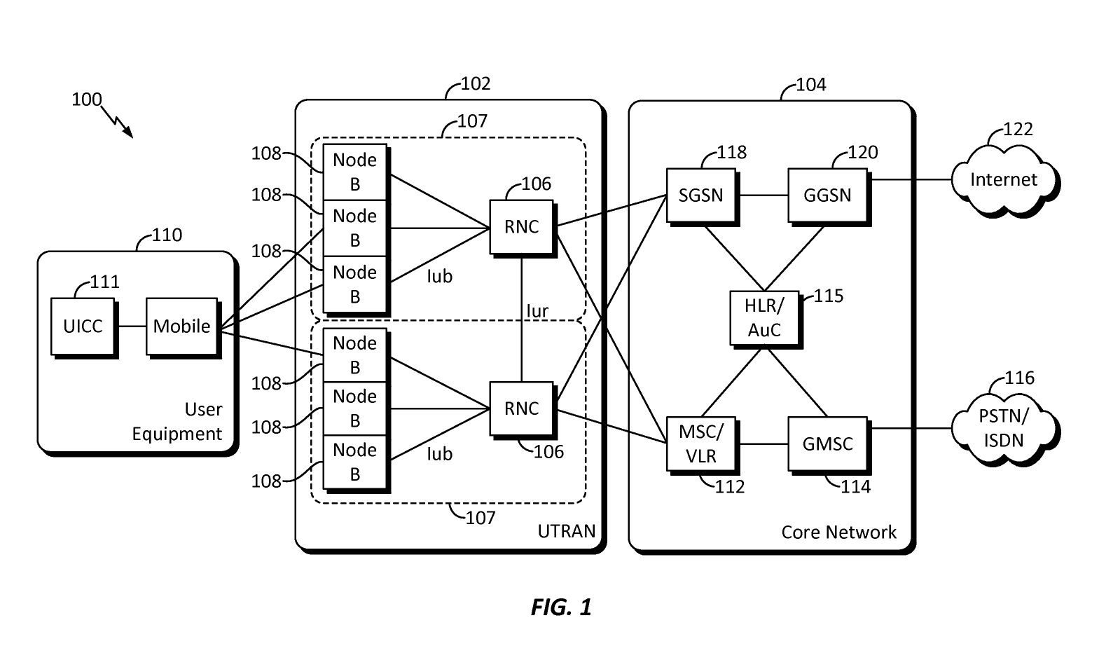

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a Universal Mobile Telecommunications System (UMTS) system 100. A UMTS network includes three interacting domains: a core network 104, a radio access network (RAN) (e.g., the UMTS Terrestrial Radio Access Network (UTRAN) 102), and a user equipment (UE) 110. Among several options available for a UTRAN 102, in this example, the illustrated UTRAN 102 may employ a W-CDMA air interface for enabling various wireless services including telephony, video, data, messaging, broadcasts, and/or other services. The UTRAN 102 may include a plurality of Radio Network Subsystems (RNSs) such as an RNS 107, each controlled by a respective Radio Network Controller (RNC) such as an RNC 106. Here, the UTRAN 102 may include any number of RNCs 106 and RNSs 107 in addition to the illustrated RNCs 106 and RNSs 107. The RNC 106 is an apparatus responsible for, among other things, assigning, reconfiguring, and releasing radio resources within the RNS 107. The RNC 106 may be interconnected to other RNCs (not shown) in the UTRAN 102 through various types of interfaces such as a direct physical connection, a virtual network, or the like using any suitable transport network.

The geographic region covered by the RNS 107 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 108 are shown in each RNS 107; however, the RNSs 107 may include any number of wireless Node Bs. The Node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology.

In a UMTS system, the UE 110 may further include a universal integrated circuit card (UICC) 111, which contains a user's subscription information to a network. For illustrative purposes, one UE 110 is shown in communication with a number of the Node Bs 108. The downlink (DL), also called the forward link, refers to the communication link from a Node B 108 to a UE 110 and the uplink (UL), also called the reverse link, refers to the communication link from a UE 110 to a Node B 108.

The core network 104 can interface with one or more access networks, such as the UTRAN 102. As shown, the core network 104 is a UMTS core network. However, as those skilled in the art will recognize, the various concepts presented throughout this disclosure may be implemented in a RAN, or other suitable access network, to provide UEs with access to types of core networks other than UMTS networks.

The illustrated UMTS core network 104 includes a circuit-switched (CS) domain and a packet-switched (PS) domain. Some of the circuit-switched elements are a Mobile services Switching Centre (MSC), a Visitor Location Register (VLR), and a Gateway MSC (GMSC). Packet-switched elements include a Serving GPRS Support Node (SGSN) and a Gateway GPRS Support Node (GGSN). Some network elements, like EIR, HLR, VLR, and AuC may be shared by both of the circuit-switched and packet-switched domains.

In the illustrated example, the core network 104 supports circuit-switched services with a MSC 112 and a GMSC 114. In some applications, the GMSC 114 may be referred to as a media gateway (MGW). One or more RNCs, such as the RNC 106, may be connected to the MSC 112. The MSC 112 is an apparatus that controls call setup, call routing, and UE mobility functions. The MSC 112 also includes a visitor location register (VLR) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) 115 containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR 115 to determine the UE's location and forwards the call to the particular MSC serving that location.

The illustrated core network 104 also supports packet-switched data services with a serving GPRS support node (SGSN) 118 and a gateway GPRS support node (GGSN) 120. General Packet Radio Service (GPRS) is designed to provide packet-data services at speeds higher than those available with standard circuit-switched data services. The GGSN 120 provides a connection for the UTRAN 102 to a packet-based network 122. The packet-based network 122 may be the Internet, a private data network, or some other suitable packet-based network. The primary function of the GGSN 120 is to provide the UEs 110 with packet-based network connectivity. Data packets may be transferred between the GGSN 120 and the UEs 110 through the SGSN 118, which performs primarily the same functions in the packet-based domain as the MSC 112 performs in the circuit-switched domain.

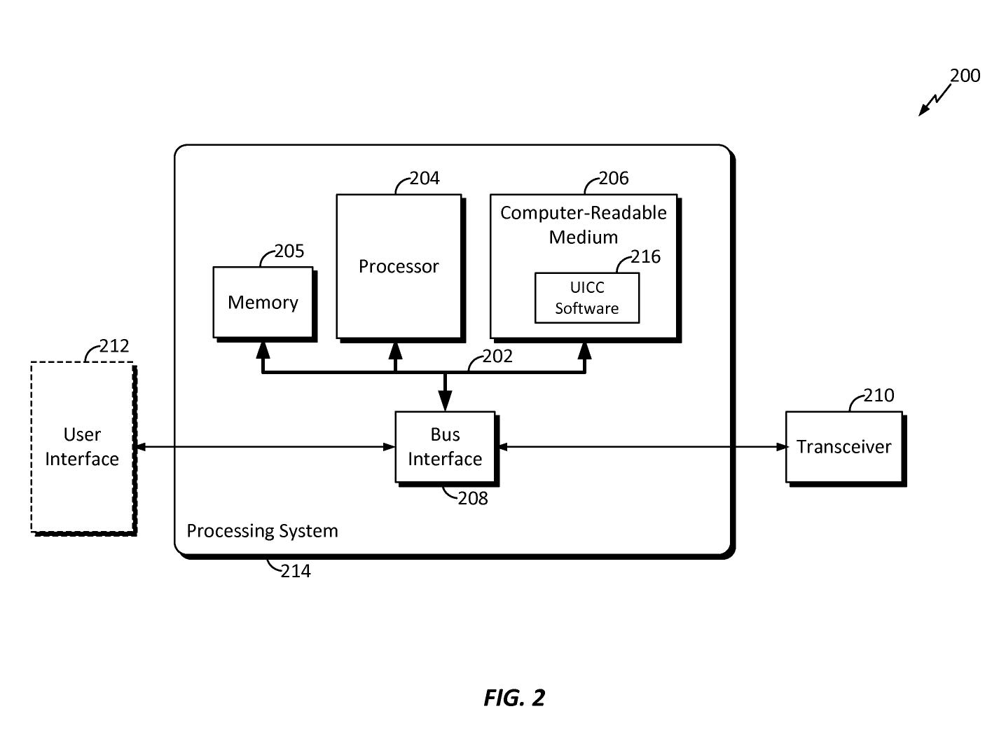

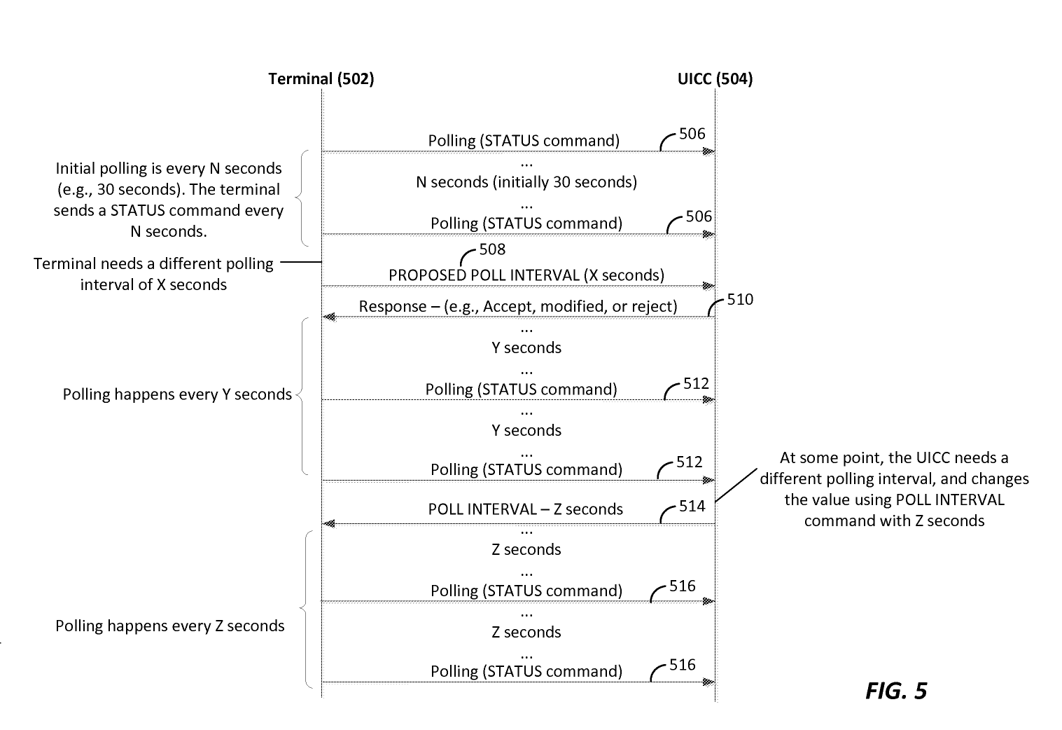

FIG. 2 is a conceptual diagram illustrating an example of a hardware implementation for an apparatus 200 employing a processing system 214. In accordance with various aspects of the disclosure, an element, or any portion of an element, or any combination of elements may be implemented with a processing system 214 that includes one or more processors 204. For example, the apparatus 200 may be a user equipment (UE) or wireless terminal as illustrated in any one or more of FIGS. 1, 4, 5, and/or 6. In another example, the apparatus 200 may be a UICC as illustrated in FIGS. 1, 3, 4, 5, and/or 6. Examples of processors 204 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. That is, the processor 204, as utilized in an apparatus 200, may be used to implement any one or more of the processes described below and illustrated in FIGS. 5-9.

In this example, the processing system 214 may be implemented with a bus architecture, represented generally by the bus 202. The bus 202 may include any number of interconnecting buses and bridges depending on the specific application of the processing system 214 and the overall design constraints. The bus 202 links together various circuits including one or more processors (represented generally by the processor 204), a memory 205, and computer-readable media (represented generally by the computer-readable medium 206). The bus 202 may also link various other circuits such as timing sources, peripherals, voltage regulators, and power management circuits, which are well known in the art, and therefore, will not be described any further. A bus interface 208 provides an interface between the bus 202 and a transceiver 210. The transceiver 210 provides a means for communicating with various other apparatus over a transmission medium. Depending upon the nature of the apparatus, a user interface 212 (e.g., keypad, touchscreen, touch pad, display, speaker, microphone, joystick) may also be provided.

The processor 204 is responsible for managing the bus 202 and general processing, including the execution of software stored on the computer-readable medium 206. The software, including UICC software 216, when executed by the processor 204, causes the processing system 214 to perform various UICC proactive polling interval negotiation processes described in FIGS. 5-9, which will be described fully below. The computer-readable medium 206 may also be used for storing data that is manipulated by the processor 204 when executing software. In an aspect of the disclosure, the UE 110 (see FIG. 1) may be implemented with the apparatus 200.

One or more processors 204 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 206. The computer-readable medium 206 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 206 may reside in the processing system 214, external to the processing system 214, or distributed across multiple entities including the processing system 214. The computer-readable medium 206 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

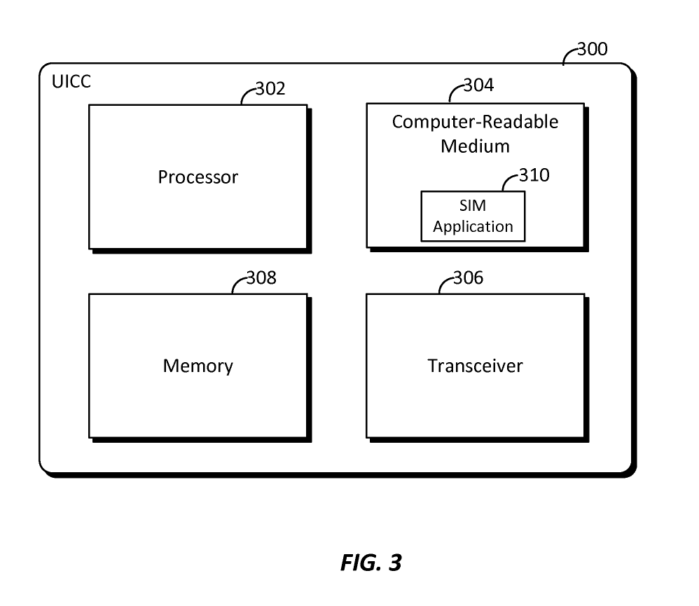

FIG. 3 is a block diagram conceptually illustrating a UICC 300 in accordance with an aspect of the disclosure. For example, the UICC 300 may be a UICC as illustrated in any one of FIGS. 1, 4, 5, and/or 6. The UICC 300 includes at least one processor 302, a computer-readable medium 304, a transceiver 306, and a memory 308. Examples of the processor 302 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. The processor 302, as utilized in a UICC 300, may be used to implement any one or more of the processes described below and illustrated in FIGS. 5-9.

The transceiver 306 provides a means for communicating with various other apparatus over a transmission medium. For example, the transceiver 306 may be used to communicate with a UE or wireless terminal through proactive and envelope commands. The processor 302 is responsible for general processing, including the execution of software stored on the computer-readable medium 304. The computer-readable medium 304 may be a non-transitory computer-readable medium. The software, including at least one SIM application 310 (e.g., USIM, CSIM, or SIM), when executed by the processor 302, causes the UICC 300 to perform the UICC polling interval negotiation processes described in relation to FIGS. 5-9, which will be described fully below. The computer-readable medium 304 may also be used for storing data that is manipulated by the processor 302 when executing software.

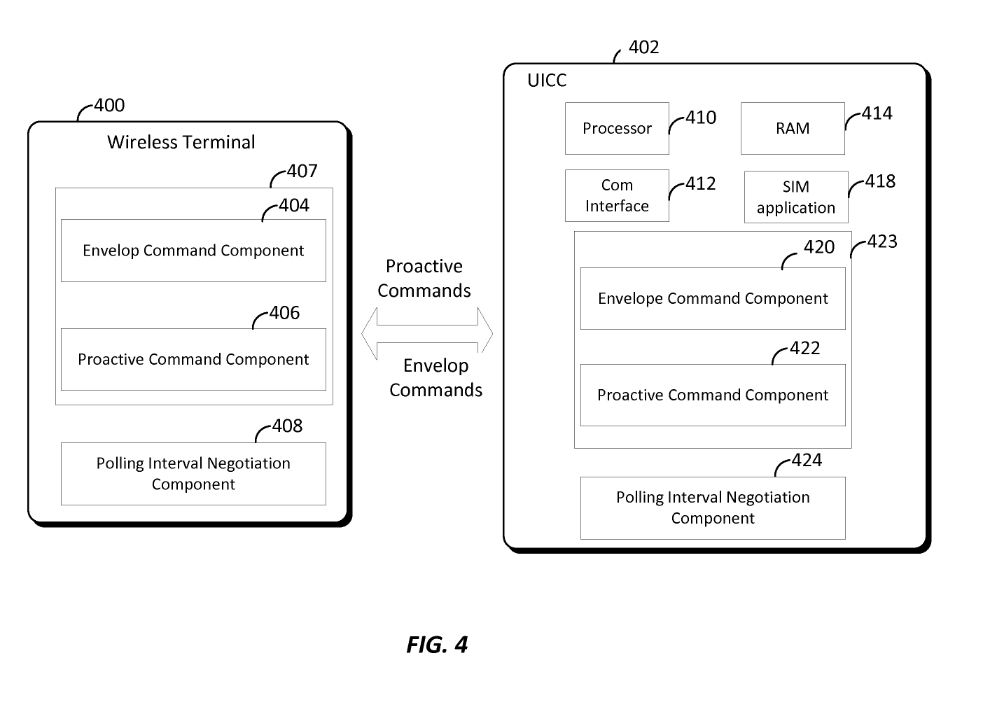

FIG. 4 is a block diagram conceptually illustrating a wireless terminal 400 and a UICC 402 configured to perform proactive polling interval negotiation in accordance with various aspects of the disclosure. For example, the wireless terminal 400 may be any of the wireless terminals illustrated in FIGS. 1, 2, 4, 5, and/or 6, and the UICC 402 may be any of the UICCs illustrated in FIGS. 1, 3, 4, 5, and/or 6. In an aspect of the disclosure, the wireless terminal 400 and UICC 402 may be configured to perform the proactive polling interval negotiation described in relation to FIGS. 5-9. The wireless terminal 400 may include an envelope command component 404, a proactive command component 406, and a polling interval negotiation component 408. The envelope command component 404 and proactive command component 406 constitute a communication component 407 that may be configured to communicate with the UICC 402 at a polling interval negotiated between the wireless terminal and the UICC. The envelope command component 404 may be configured to prepare and send various envelope commands to the UICC 402. The proactive command component 406 may be configured to receive and process various proactive commands from the UICC. The polling interval negotiation component 408 may be configured to handle polling interval negotiation between the wireless terminal 400 and UICC 402 in accordance with the processes described in related to FIGS. 5-9 below. In one example, the polling interval negotiation component 408 may be configured to negotiate a polling interval with the UICC 402 by sending at least one proposed polling interval to the UICC. In one example, the communication component 407 may be configured to change the polling interval from a first polling interval to a second polling interval based on a response of the UICC 402 to the proposed polling interval.

When UICC software (e.g., UICC software 216 of FIG. 2) is executed by the wireless terminal 400, various components of the wireless terminal 400 including, for example, the envelope command component 404, proactive command component 406, and polling interval negotiation component 408, may be configured to perform the various functions described in reference to FIGS. 5-9. The various components of the wireless terminal 400 may be implemented in software, hardware, firmware, and/or a combination thereof.

Some functional blocks of the UICC 402 are illustrated in FIG. 4. However, it should be appreciated that other commonly known components of the UICC may be omitted for clarity. Referring to FIG. 4, the UICC 402 includes a processor 410, a communication interface 412, a random access memory (RAM) 414, and a SIM application 418. The SIM application 418 may be the same as the SIM application 310 of FIG. 3. In an aspect of the disclosure, the UICC 402 further includes an envelope command component 420, a proactive command component 422, and a polling interval negotiation component 424. The envelope command component 420 and proactive command component 422 constitute a communication component 423 that may be configured to communicate with the wireless terminal 400 at a polling interval negotiated between the UICC and wireless terminal.

Various components of the UICC 402, including the envelope command component 420, proactive command component 422, and polling interval negotiation component 424, may be configured to perform the UICC functions as described in reference to FIGS. 5-9. The various components of the UICC 402 may be implemented in software, hardware, firmware, and/or a combination thereof. For example, the envelope command component 420 may be configured to receive and process various envelope commands from the wireless terminal. The proactive command component 422 may be configured to prepare and send various proactive commands to the wireless terminal. The polling interval negotiation component 424 may be configured to handle polling interval negotiation between the wireless terminal 400 and UICC 402 in accordance with the processes described in related to FIGS. 5-9 below. In one example, the polling interval negotiation component 424 may be configured to negotiate a polling interval with the wireless terminal 400 by receiving at least one proposed polling interval from the wireless terminal. In one example, the communication component 423 may be configured to change the polling interval from a first polling interval to a second polling interval based on a response of the UICC to the proposed polling interval.

FIG. 5 is a communication flow diagram illustrating proactive polling interval negotiation between a wireless terminal 502 and a UICC 504 in accordance with an aspect of the present disclosure. For example, the wireless terminal 502 may be any of the wireless terminals illustrated in FIGS. 1, 2, 4, and/or 6, and the UICC 504 may be any of the UICCs illustrated in FIGS. 1, 2, 3, 4, and/or 6. In FIG. 5, new commands are introduced that are used by the wireless terminal 502 and UICC 504 to negotiate a desired proactive polling interval, as per wireless terminal needs. In one aspect of the disclosure, the wireless terminal 502 may send a TERMINAL PROFILE command to describe which CAT facilities are supported by the wireless terminal 502. For example, the profile may indicate that the wireless terminal 502 supports a proactive polling interval negotiation service and the corresponding commands. If proactive polling interval negotiation is also supported by the UICC 504, then the wireless terminal 502 may negotiate a polling interval with the UICC 504.

In one aspect of the disclosure, the wireless terminal 502 may request to negotiate a proactive polling interval with the UICC 504 by sending an envelope command (e.g., POLLING INTERVAL command). When the wireless terminal 502 proposes a new polling interval, the UICC 504 may accept, reject, or modify it. After the execution of the POLLING INTERVAL command, the wireless terminal 502 may start using the negotiated polling interval if it is accepted by the UICC 504. The wireless terminal 502 should not negotiate a polling interval if proactive polling is not supported or disabled by the UICC 504. For example, the UICC 504 may disable polling by sending a POLLING OFF commands. The UICC 504 may modify the polling interval negotiated with the wireless terminal 502 using a POLL INTERVAL command.

Referring to FIG. 5, it is assumed that the wireless terminal 502 and UICC 504 are initially communicating with a first polling interval (N seconds). For example, the wireless terminal 502 may be sending STATUS commands 506 to the UICC 504 every thirty seconds. At a certain time, the wireless terminal 502 may need a different polling interval. When the wireless terminal 502 desires to change the polling interval, the wireless terminal 502 sends an envelope command (PROPOSED POLL INTERVAL) 508 with a proposed polling interval (e.g., X seconds) to the UICC 504. In one aspect of the disclosure, parameters of the command 508 may include a time duration for the polling interval proposed by the terminal.

The UICC 504 may return a response 510 (e.g., a proactive command) that may indicate acceptance, modification, or rejection of the proposed polling interval. In one aspect of the disclosure, the response 510 may include a time duration parameter indicating the polling interval requested by the UICC 504. This parameter may indicate that the UICC modified the requested polling interval and should be used by the wireless terminal 502 as the new poll interval. In case the proposed polling interval is rejected by the UICC 504, the duration parameter of the response 510 is optional. When the duration parameter is included in the response 510, it may indicate the closest polling interval to the proposed interval that the UICC 504 would accept, and the wireless terminal 502 may use this polling interval going forward. If the UICC 504 accepts the proposed polling interval, the time duration parameter of the response 510 may be ignored by the wireless terminal 502.

In one aspect of the disclosure, if the UICC 504 accepts the proposed polling interval of X seconds, the wireless terminal 502 will start sending polling commands to the UICC 504 every X seconds. In another example, if the UICC 504 sends a modified polling interval of Y seconds as a response that is acceptable to the wireless terminal 502, the terminal 502 will send polling commands 512 to the UICC 504 every Y seconds going forward. In another example, if the UICC 504 rejects the proposed polling interval, the wireless terminal 502 maintains the current polling interval. The wireless terminal 502 and UICC 504 may go through multiple rounds of negotiation (e.g., multiple rounds of proposal 508 and response 510) before the polling interval is determined. In another aspect of the disclosure, the UICC 504 may provide no response to the proposed polling interval. In this case, if the UICC 504 provides no response, then the wireless terminal 502 may interpret that as an acceptance of the proposed polling interval with no modification.

At any point in time, however, the UICC 504 may change the current polling interval. For example, the UICC 504 may send a POLL INTERVAL command 514 to modify the current proactive polling interval to be Z seconds. In response, the wireless terminal 502 sends polling commands 516 every Z seconds. With the above-described ability to negotiate the polling interval, the UICC 504 can maintain control over the proactive polling interval (which might be important for the operator), but can better adapt to the needs of the wireless terminal 502 and its power saving behavior. In some examples, the command 514 may be a POLLING OFF command that will cause the wireless terminal 502 stop sending polling commands.

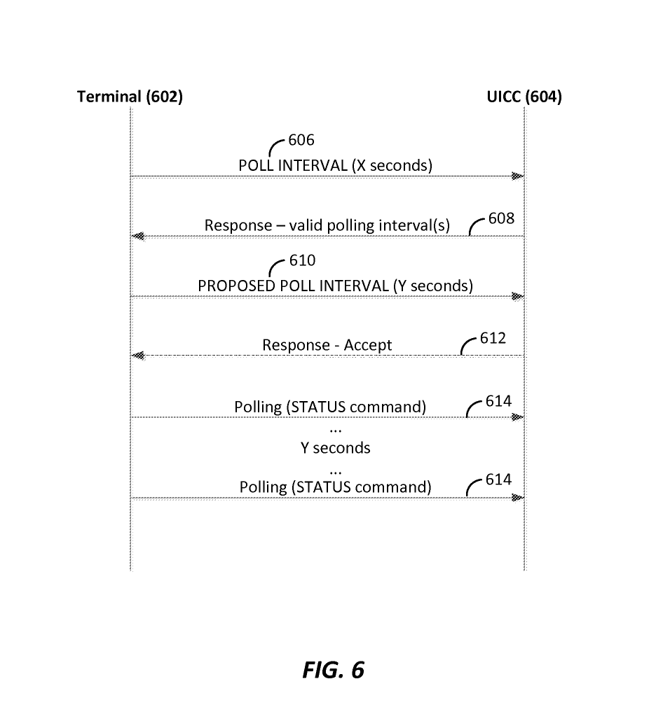

FIG. 6 is a communication flow diagram illustrating proactive polling interval negotiation between a wireless terminal 602 and a UICC 604 in accordance with an aspect of the disclosure. For example, the wireless terminal 602 may be any of the terminals illustrated in FIGS. 1, 2, 4, and/or 5, and the UICC 604 may be any of the UICCs illustrated in FIGS. 1, 2, 3, 4, and/or 5. Referring to FIG. 6, a wireless terminal 602 may send a PROPOSED POLL INTERVAL command to request a polling interval of X seconds. In this case, the UICC 604 may modify, or reject the requested polling interval by sending a response 608 including at least one valid polling interval or a range of valid polling intervals, that are different from the requested polling interval. The wireless terminal 602 may select a polling interval from among the provided valid polling intervals as the new polling interval going forward. For example, the wireless terminal 602 may respond by sending a PROPOSED POLL INTERVAL command 610 to select a polling interval of Y seconds, which is one of the valid polling intervals provided by the UICC 604. In one aspect of the disclosure, the UICC 604 may send a response 612 to confirm acceptance of the polling interval. In another aspect of the disclosure, the UICC 604 may not send a response, and the wireless terminal 602 may consider an absence of a response or command from the UICC as an acceptance of the proposed or selected polling interval. Thereafter, the wireless terminal 602 sends polling commands to the UICC 604 every Y seconds. In other words, the wireless terminal 602 communicates with the UICC 604 at a polling interval of Y seconds.

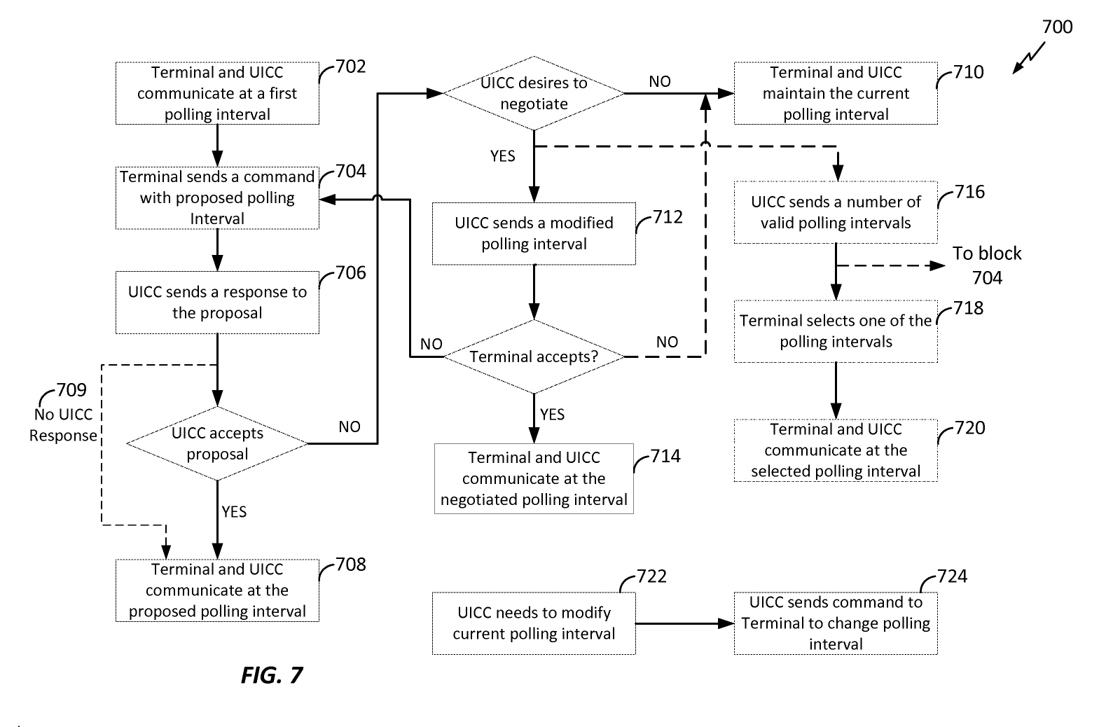

FIG. 7 is a flow chart 700 illustrating an example of proactive polling interval negotiation between a wireless terminal and a UICC in accordance with an aspect of the present disclosure. For example, the wireless terminal may be any of the wireless terminals illustrated in FIGS. 1, 2, and 4-6, and the UICC may be any of the UICCs illustrated in FIGS. 1-6. At block 702, the wireless terminal and UICC are initially communicating at a first polling interval. For example, the wireless terminal may send a status command 506 to the UICC every thirty seconds (see FIG. 5). At block 704, if the wireless terminal desires to change the polling interval, the terminal sends a command with a proposed polling interval (a second polling interval). For example, the wireless terminal may send an envelope command 508 (see FIG. 5) with a proposed polling interval (proposal) equal to X seconds. Then, at block 706, the UICC may send a response (e.g., response 510 of FIG. 5) to indicate acceptance, rejection, or modification of the proposed polling interval. If the UICC accepts the proposal, the wireless terminal may start sending polling commands to the UICC at the proposed polling interval (X seconds) going forward at block 708. If the UICC rejects the proposal, the process proceeds to block 710, 712, or 716 depending on whether or not the UICC desires to negotiate the polling interval. In some aspects of the disclosure, the UICC may not send a response to the proposed polling interval, and the wireless terminal may interpret the absence or lack of response 709 as an acceptance of the proposed polling interval.

If the UICC does not desire to negotiate, the wireless terminal and UICC may maintain the current polling interval at block 710. If the UICC wants to negotiate, it may send a modified polling interval to the wireless terminal at block 712. The wireless terminal may accept and communicate with the UICC at the modified (negotiated) polling interval going forward at block 714. If the wireless terminal does not accept the modified polling interval, the wireless terminal may repeat the negotiation process starting at block 704. In some aspects of the disclosure, if the wireless terminal does not accept the modified polling interview, the wireless terminal may maintain the current polling interval and proceed to, for example, block 710.

In an aspect of the disclosure, the UICC may send a number or a range of valid polling intervals different from the proposal to the wireless terminal at block 716 as the response to the proposal. The wireless terminal may select one of the valid polling intervals at block 718, and the terminal will communicate with the UICC at the selected polling interval going forward at block 720. Alternatively, the wireless terminal may not select any of the polling intervals proposed by the UICC and repeat the negotiation process starting at block 704. In another aspect of the disclosure, after the UICC sends a number or a range of valid polling intervals at block 716, the communication may proceed to block 704 where the wireless terminal may send a command with one of the valid polling intervals as a proposed polling interval.

At any point in time, the UICC may modify the current proactive polling interval at block 722. In an aspect of the disclosure, the UICC may send a POLL INTERVAL or POLLING OFF command to change the current polling interval to a desired value, at block 724. For example, the UICC may send a POLL INTERVAL command 514 (see FIG. 5) to the wireless terminal.

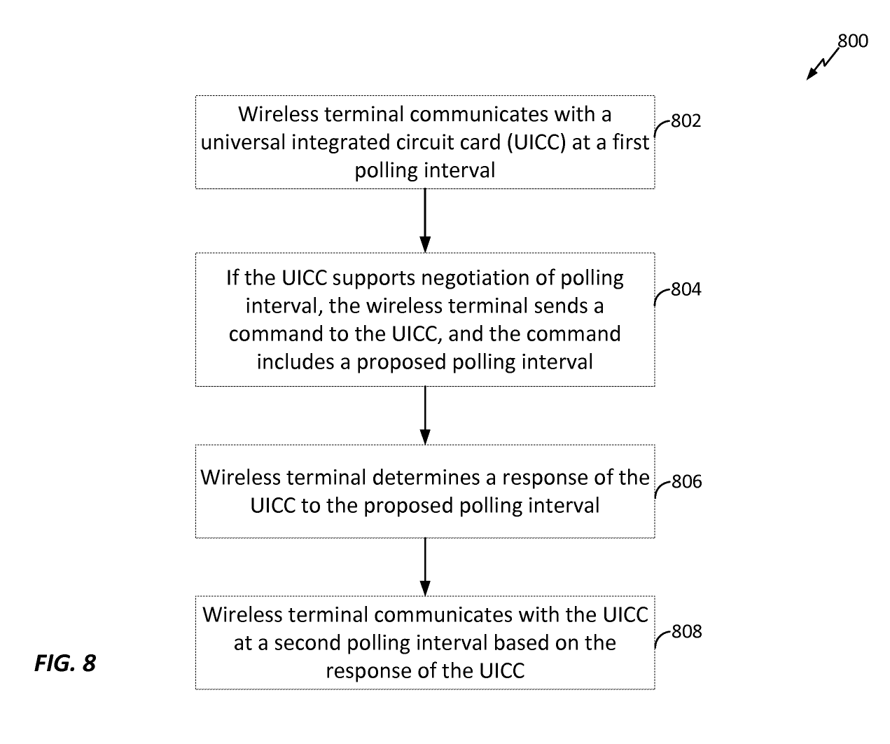

FIG. 8 is a flow chart 800 illustrating a method of polling interval negotiation operable at a wireless terminal in accordance with an aspect of the disclosure. For example, the wireless terminal may be any of the wireless terminals illustrated in FIGS. 1, 2, 4, 5, and/or 6. At block 802, the wireless terminal communicates with a UICC at a first polling interval. For example, the UICC may be any of the UICCs illustrated in FIGS. 1-6. In an aspect of the disclosure, the first polling interval may be X seconds (e.g., 30 seconds). At block 804, if the UICC supports negotiation of polling interval, the wireless terminal may send a command to the UICC to change the polling interval, and the command includes a proposed polling interval. For example, the command may be a PROPOSED POLL INTERVAL command 508 (see FIG. 5). At block 806, the wireless terminal determines a response of the UICC to the proposed polling interval. For example, the response may be a response 510 (see FIG. 5) that can accept, reject, or modify the proposed polling interval. At block 808, the wireless terminal communicates with the UICC at a second polling interval based on the response of the UICC. For example, the second polling interval may be Y seconds as illustrated in FIG. 5. If the UICC accepts the proposed polling interval, the first and second polling intervals may be the same. Otherwise, the second polling interval may be different from the first polling interval.

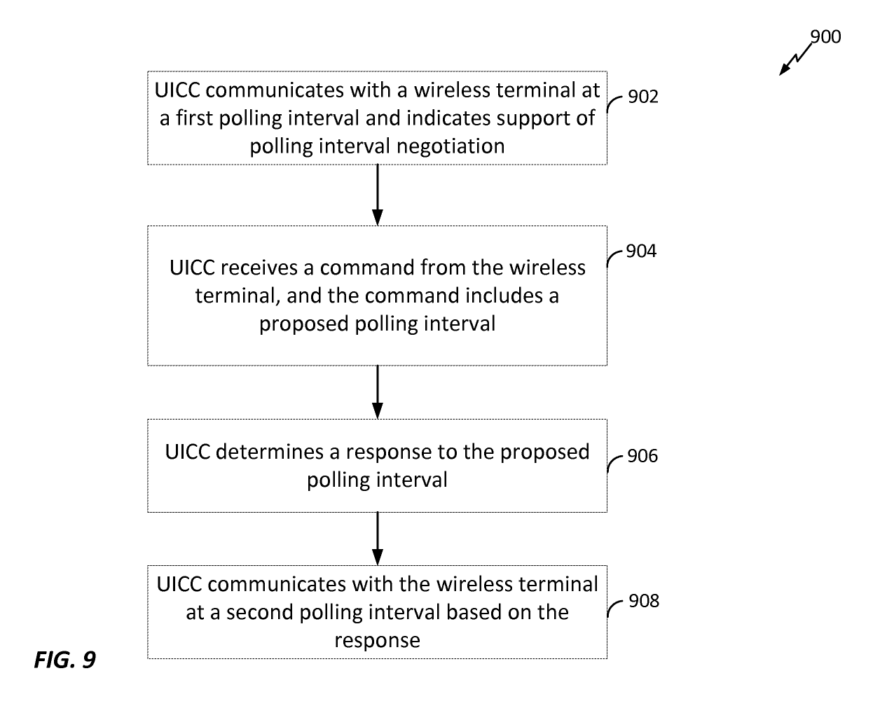

FIG. 9 is a flow chart 900 illustrating a method of proactive polling interval negotiation operable at a UICC in accordance with an aspect of the disclosure. At block 902, the UICC communicates with a wireless terminal at a first polling interval and indicates support of polling interval negotiation. For example, the UICC may be any of the UICCs illustrated in FIGS. 1-6, the wireless terminal may be any of the wireless terminals illustrated in FIGS. 1, 2 and 4-6. In one aspect of the disclosure, the first polling interval may be X seconds (e.g., 30 seconds). At block 904, the UICC receives a command from the wireless terminal, and the command includes a proposed polling interval. In an example, the command may be a PROPOSED POLL INTERVAL command 508 (see FIG. 5). At block 906, the UICC determines a response to the proposed polling interval. For example, the response may be a response 510 (see FIG. 5), which may indicate acceptance, rejection, or modification of the proposed polling interval. At block 908, the UICC communicates with the wireless terminal at a second polling interval based on the response. For example, the second polling interval may be Y seconds as illustrated in FIG. 5. If the UICC accepts the proposed polling interval, the first and second polling intervals may be the same. Otherwise, the first and second polling intervals may be different.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of operating a wireless terminal, comprising:
communicating with a universal integrated circuit card (UICC) at a first polling interval;
sending a command to the UICC, wherein the command comprises a proposed polling interval;
determining a response of the UICC to the proposed polling interval; and
communicating with the UICC at a second polling interval based on the response of the UICC.

2. The method of claim 1, wherein determining the response of the UICC comprises determining that the proposed polling interval is accepted, rejected, or modified by the UICC.

3. The method of claim 1, wherein determining the response of the UICC comprises determining that the response of the UICC comprises at least one third polling interval supported by the UICC that is different from the first polling interval.

4. The method of claim 3,
wherein the at least one third polling interval comprises a plurality of third polling intervals, and
wherein determining the response of the UICC comprises selecting one of the third polling intervals as the second polling interval.

5. The method of claim 1, wherein determining the response of the UICC comprises interpreting a lack of response from the UICC as an acceptance of the proposed polling interval.

6. A method of operating a universal integrated circuit card (UICC), comprising:
communicating with a wireless terminal at a first polling interval and indicating support of polling interval negotiation;
receiving a command from the wireless terminal, wherein the command comprises a proposed polling interval;
determining a response to the proposed polling interval; and
communicating with the wireless terminal at a second polling interval based on the response.

7. The method of claim 6, wherein determining the response comprises communicating to the wireless terminal an acceptance, rejection, or modification of the proposed polling interval.

8. The method of claim 6, wherein determining the response comprises sending to the wireless terminal at least one third polling interval supported by the UICC that is different from the first polling interval.

9. The method of claim 8, wherein the at least one third polling interval comprises a plurality of third polling intervals, the method further comprising:
receiving a command from the wireless terminal selecting one of the third polling intervals as the second polling interval.

10. The method of claim 6, wherein determining the response comprises sending no response to the command of the wireless terminal as an acceptance of the proposed polling interval.

11. A wireless terminal, comprising:
means for communicating with a universal integrated circuit card (UICC) at a first polling interval;
means for sending a command to the UICC, wherein the command comprises a proposed polling interval;
means for determining a response of the UICC to the proposed polling interval; and
means for communicating with the UICC at a second polling interval based on the response from the UICC.

12. The wireless terminal of claim 11, wherein the means for determining the response is configured to determine that the proposed polling interval is accepted, rejected, or modified by the UICC.

13. The wireless terminal of claim 11, wherein the means for determining the response is configured to determine that the response of the UICC comprises at least one third polling interval supported by the UICC that is different from the first polling interval.

14. The wireless terminal of claim 13,
wherein the at least one third polling interval comprises a plurality of third polling intervals, and
wherein the means for determining the response is configured to select one of the third polling intervals as the second polling interval.

15. The wireless terminal of claim 11, wherein the means for determining the response is configured to interpret a lack of response from the UICC as an acceptance of the proposed polling interval.

16. A universal integrated circuit card (UICC), comprising:
means for communicating with a wireless terminal at a first polling interval and indicating support of polling interval negotiation;
means for receiving a command from the wireless terminal, wherein the command comprises a proposed polling interval;
means for determining a response to the proposed polling interval; and
means for communicating with the wireless terminal at a second polling interval based on the response.

17. The UICC of claim 16, wherein the means for determining the response is configured to communicate to the wireless terminal an acceptance, rejection, or modification of the proposed polling interval.

18. The UICC of claim 16, wherein the means for determining the response is configured to send to the wireless terminal at least one third polling interval supported by the UICC that is different from the first polling interval.

19. The UICC of claim 18,
wherein the at least one third polling interval comprises a plurality of third polling intervals, and
wherein the means for determining the response is configured to receive a command from the wireless terminal selecting one of the third polling intervals as the second polling interval.

20. The UICC of claim 16, wherein the means for determining the response is configured to send no response to the command of the wireless terminal as an acceptance of the proposed polling interval.

21. A wireless terminal, comprising:
at least one processor;
a communication interface coupled to the at least one processor; and
a memory coupled to the at least one processor,
wherein the at least one processor comprises:
a first component configured to communicate with a universal integrated circuit card (UICC) at a first polling interval;
a second component configured to send a command to the UICC, wherein the command comprises a proposed polling interval;
a third component configured to determine a response to the proposed polling interval; and
a fourth component configured to communicate with the UICC at a second polling interval based on the response of the UICC.

22. The wireless terminal of claim 21, wherein the third component is further configured to determine that the proposed polling interval is accepted, rejected, or modified by the UICC.

23. The wireless terminal of claim 21, wherein the third component is further configured to determine that the response of the UICC comprises at least one third polling interval supported by the UICC that is different from the first polling interval.

24. The wireless terminal of claim 23,
wherein the at least one third polling interval comprises a plurality of third polling intervals, and
wherein the third component is further configured to select one of the third polling intervals as the second polling interval.

25. The wireless terminal of claim 21, wherein the third component is further configured to interpret a lack of response from the UICC as an acceptance of the proposed polling interval.

26. A universal integrated circuit card (UICC), comprising:
at least one processor;
a communication interface coupled to the at least one processor; and
a memory coupled to the at least one processor,
wherein the at least one processor comprises:
a first component configured to communicate with a wireless terminal at a first polling interval and indicate support of polling interval negotiation;
a second component configured to receive a command from the wireless terminal, wherein the command comprises a proposed polling interval;
a third component configured to determine a response to the proposed polling interval; and
a fourth component configured to communicate with the wireless terminal at a second polling interval based on the response.

27. The UICC of claim 26, wherein the third component is further configured to communicate to the wireless terminal an acceptance, rejection, or modification of the proposed polling interval.

28. The UICC of claim 26, wherein the third component is further configured to send to the wireless terminal at least one third polling interval supported by the UICC that is different from the first polling interval.

29. The UICC of claim 28,
wherein the at least one third polling interval comprises a plurality of third polling intervals, and
wherein the third component is further configured to receive a command from the wireless terminal selecting one of the third polling intervals as the second polling interval.

30. The UICC of claim 26, wherein the third component is further configured to send no response to the command of the wireless terminal as an acceptance of the proposed polling interval.

31. A wireless terminal, comprising:
a communication component configured to communicate with a universal integrated circuit card (UICC) at a polling interval negotiated between the wireless terminal and the UICC; and
a polling interval negotiation component configured to negotiate the polling interval with the UICC by sending at least one proposed polling interval to the UICC,
wherein the communication component is configured to change the polling interval from a first polling interval to a second polling interval based on a response of the UICC to the proposed polling interval.

32. The wireless terminal of claim 31, wherein the polling interval negotiation component is configured to determine that the response to the proposed polling interval is accepted, rejected, or modified by the UICC.

33. The wireless terminal of claim 31, wherein the polling interval negotiation component is configured to determine that the response of the UICC comprises at least one third polling interval supported by the UICC that is different from the first polling interval.

34. The wireless terminal of claim 33,
wherein the at least one third polling interval comprises a plurality of third polling intervals, and
wherein the polling interval negotiation component is further configured to select one of the third polling intervals as the second polling interval.

35. The wireless terminal of claim 31, wherein the polling interval negotiation component is configured to interpret a lack of response from the UICC as an acceptance of the proposed polling interval.

36. A universal integrated circuit card (UICC), comprising:
a communication component configured to communicate with a wireless terminal at a polling interval negotiated between the UICC and the wireless terminal; and
a polling interval negotiation component configured to negotiate the polling interval with the wireless terminal by receiving at least one proposed polling interval from the wireless terminal,
wherein the communication component is configured to change the polling interval from a first polling interval to a second polling interval based on a response of the UICC to the proposed polling interval.

37. The UICC of claim 36, wherein the polling interval negotiation component is configured to generate the response comprising an acceptance, rejection, or modification of the proposed polling interval.

38. The UICC of claim 36, wherein the polling interval negotiation component is configured to generate the response comprising at least one third polling interval supported by the UICC that is different from the first polling interval.

39. The UICC of claim 38,
wherein the at least one third polling interval comprises a plurality of third polling intervals, and
wherein the polling interval negotiation component is further configured to receive a command from the wireless terminal selecting one of the third polling intervals as the second polling interval.

40. The UICC of claim 36, wherein the polling interval negotiation component is configured to generate no response to the proposed polling interval as an acceptance of the proposed polling interval.
